(19) United States
(12) Patent Application Publication
(10) Pub. No.: US 2026/0230678 A1
(43) Pub. Date: Aug. 6, 2026

(54) INFORMATION PROCESSING METHOD AND APPARATUS, DEVICE, MEDIUM, AND PROGRAM PRODUCT

(71) Applicant: Tencent Technology (Shenzhen) Company Limited, Shenzhen (CN)

(72) Inventor: Junbin LIANG, Shenzhen (CN)

(21) Appl. No.: 19/635,433

(22) Filed: Mar. 31, 2026

Related U.S. Application Data
(63) Continuation of application No. PCT/CN2025/070429, filed on Jan. 3, 2025.

(30) Foreign Application Priority Data
Jan. 26, 2024 (CN) 202410112762.4

(51) Int. Cl. H04N 21/472; H04N 21/43

(52) U.S. Cl. CPC H04N 21/47217; H04N 21/4307

(57) ABSTRACT

Embodiments of this application disclose an information processing method performed by a computer device. When the information to be played which is configured to be played at a target playing moment, is related to the target content progress, and there are relatively large differences among content progresses respectively corresponding to the information to be played of different information types, information synchronization adjustment is performed on the target playing moment, to ensure that a content related to the target content progress does not have a significant information synchronization problem during playing. If the information to be played is not related to the target content progress, the intensity of information synchronization adjustment can be reduced to reduce the amount of information that needs to be processed. This application enables the played information to be more complete and authentic while ensuring the content browsing experience.

### CROSS-REFERENCE TO RELATED APPLICATIONS

This application is a continuation application of PCT Patent Application No. PCT/CN2025/070429, entitled “INFORMATION PROCESSING METHOD AND APPARATUS, DEVICE, MEDIUM, AND PROGRAM PRODUCT” filed on January 3, 2025, which claims priority to Chinese Patent Application No. 2024101127624, entitled "INFORMATION PROCESSING METHOD AND RELATED APPARATUS" and filed with the China National Intellectual Property Administration on January 26, 2024, all of which are incorporated herein by reference in their entirety.

### FIELD OF THE TECHNOLOGY

This application relates to the field of information technologies, and in particular, to information processing.

### BACKGROUND OF THE DISCLOSURE

Audio and video synchronization is a key factor affecting an information playing effect in a plurality of scenarios. For example, in a video communication scenario, if audio and video synchronization cannot be implemented, video information seen by a communication party cannot correspond to audio information heard by the communication party, resulting in that effective video communication cannot be performed.

In a related technology, to ensure audio and video synchronization, time stamp detection is performed on the video information and audio information to be played, so as to determine whether the video information and audio information to be played are synchronized in time. When it is detected that an audio and a video are not synchronized, information is processed, so as to ensure that the played audio information and video information are relatively synchronized in time.

However, in an information processing mode in the related technology, any audio and video information having an asynchronization phenomenon is processed. Although an audio and video synchronization effect of the played information can be ensured, a large quantity of information processing resources are occupied, a large quantity of information processing time is consumed, and problems such as information frame freezing and loss are easily caused when the information is played.

### SUMMARY

To solve the foregoing technical problem, this application provides an information processing method, so that information synchronization adjustment may be performed on the content that easily affects synchronous information browsing experience of a subject that browses information, thereby reducing a processing capacity of information synchronization adjustment while ensuring the information browsing experience.

Embodiments of this application disclose the following technical solutions:

According to a first aspect, an embodiment of this application discloses an information processing method, the method including:

acquiring first information to be played and second information to be played which are configured to be played at a target playing moment, the first information to be played corresponding to a first information type of a target content at a first content progress, the second information to be played corresponding to a second information type of the target content at a second content progress;

determining first information corresponding to the first information type according to the first information to be played, and second information corresponding to the second information type according to the second information to be played when the second content progress and a progress difference between the first content progress and the second content progress is greater than a first difference threshold; and

playing the first information and the second information at the target playing moment, a difference between content progresses respectively corresponding to the first information and the second information in the target content being not greater than the first difference threshold.

In a possible implementation, a third content progress is located between the first content progress and the second content progress.

According to a second aspect, an embodiment of this application discloses a computer device, including a processor and a memory:

the memory being configured to store a computer program and transmit the computer program to the processor; and

the processor being configured to perform the information processing method according to any implementation in the first aspect based on an instruction in the computer program.

According to a third aspect, an embodiment of this application discloses a non-transitory computer-readable storage medium, configured to store a computer program, the computer program being configured for performing the information processing method according to any implementation in the first aspect.

It can be seen from the foregoing technical solution that a first device may play the target content by playing the information respectively corresponding to the first information type and the second information type of the target content at each content progress. In this application, after the first information to be played and the second information to be played which are configured to be played at the target playing moment are acquired, instead of directly playing the first information to be played and the second information to be played at the target playing moment, a content progress difference between the two pieces of information to be played is first analyzed, and whether the content progress corresponding to the two pieces of information to be played includes the target content progress is analyzed. The information respectively corresponding to the first information type and the second information type both changes when the target content is at the target content progress, and an information change in the first information type is a reason of an information change in the second information type. Therefore, when the information corresponding to one information type of the target content at the target content progress is played, a difference between the played information corresponding to the other information type and the target content progress is relatively large, and a content browsing party easily perceives that the browsed content is not synchronized in the two information types, affecting the content browsing experience of the content browsing party. Otherwise, if the target content progress is not included, the content browsing party has a relatively small perceived intensity of whether the content played at this moment has an information progress difference, and therefore, the progress difference has a relatively small impact on the content browsing experience of the content browsing party. Therefore, based on that a target content progress exists in the first content progress and the second content progress and a progress difference between the first content progress and the second content progress is greater than the first difference threshold, information synchronization processing is performed on the information played at the target playing moment, i.e., the first information corresponding to the first information type and the second information corresponding to the second information type are respectively determined according to the first information to be played and the second information to be played, so that a difference between content progresses respectively corresponding to the first information and the second information is not greater than the first difference threshold. The first information and the second information may be played at the target playing moment to replace original first information to be played and second information to be played, so that the content browsing party can browse the content that is relatively consistent in a plurality of information types at the target playing moment. In this application, when the information synchronization adjustment is performed, only the information that has a progress difference and greatly affects the content browsing experience is adjusted, and the information that needs to be played at each moment when the progress difference exists does not need to be adjusted. Therefore, the content browsing experience is ensured, and an adjustment amount of the information synchronization adjustment is reduced, thereby reducing an amount of information that needs to be discarded, prolonged/slowly played, or processed otherwise during the information synchronization adjustment, helping the content browsing party to browse more complete and authentic content during content browsing, and also reducing the information processing duration. This application is more applicable to scenarios having relatively high real-time requirements for content playing.

### BRIEF DESCRIPTION OF THE DRAWINGS

FIG. 1 is a schematic diagram of an information processing method in an actual application scenario according to an embodiment of this application.

FIG. 2 is a flowchart of an information processing method according to an embodiment of this application.

FIG. 3 is a schematic diagram of an information processing method according to an embodiment of this application.

FIG. 4 is a schematic diagram of an information processing method according to an embodiment of this application.

FIG. 5 is a signaling diagram of an information processing method in an actual application scenario according to an embodiment of this application.

FIG. 6 is a structural block diagram of an information processing apparatus according to an embodiment of this application.

FIG. 7 is a structural diagram of a terminal according to an embodiment of this application.

FIG. 8 is a structural diagram of a server according to an embodiment of this application.

### DESCRIPTION OF EMBODIMENTS

The following describes the embodiments of this application with reference to the accompanying drawings.

The information synchronization adjustment is one of common technical means of playing a content including a plurality of information types. For example, when the content is a video content, the content includes information of two information types: image information and audio information. By means of the information synchronization adjustment, a subject viewing a video can browse the image information and audio information corresponding to the similar content progress of the video content, thereby ensuring the video viewing experience of the subject.

In the related technology, whether the information synchronization adjustment is performed completely depends on a difference between content progresses corresponding to the information of each information type of the content to be played. For example, taking a video content as an example, a difference threshold is set in the related technology. After image information and audio information that are configured to be played at a next playing moment are acquired, corresponding content progresses (such as a frame number and a second number) of the image information and the audio information in the video content are respectively determined. If a difference between the content progresses of the image information and the audio information in the video content is greater than the difference threshold, it is determined that playing the image information and the audio information at the same moment causes a problem of sound and picture asynchronization. Therefore, information synchronization adjustment is performed on the playing moment, so that the difference between the content progresses respectively corresponding to the image information and the audio information that are actually played at the playing moment is relatively small. In this case, it is difficult for a user viewing the video content to perceive.

However, during information synchronization adjustment, methods such as deletion of some information and information deformation are usually used, and in the information synchronization adjustment mode in the related technology, there is a large amount of information that requires the information synchronization adjustment. Therefore, in the related technology, much information is deleted or deformed (for example, lengthened or shortened) in the played content. Consequently, the content browsed by a content browsing party has poor quality, which is difficult to bring a good content browsing experience. In addition, a relatively large information processing amount is needed, the information processing pressure is relatively large, and it is not suitable for scenarios having relatively high requirements for content playing instantaneity, such as real-time transmission.

To solve the foregoing technical problems, this application provides an information processing method. During information synchronization adjustment, whether the information to be played relates to a target content progress is determined. The information corresponding to a first information type and a second information type of a target content at the target content progress both changes, and a change in the first information type is a reason of an information change in the second information type. Therefore, during content playing, whether information asynchronization occurs in content at the target content progress is easily perceived by the content browsing party. If the information to be played which is configured to be played at a target playing moment, is related to the target content progress, and there are relatively large differences among content progresses respectively corresponding to the information to be played of different information types, information synchronization adjustment is performed on the target playing moment, so as to ensure that a content related to the target content progress does not have a significant information synchronization problem during playing. If the information to be played is not related to the target content progress, the intensity of information synchronization adjustment can be reduced to reduce the amount of information that needs to be processed. This application enables the played information to be more complete and authentic while ensuring the content browsing experience, and is also more suitable for content playing scenarios having relatively high real-time requirements.

The method may be applied to a computer device. The computer device is a computer device capable of processing and playing information, such as a terminal device or a server. The method may be performed independently by a terminal device, or may be applied to a network scenario in which the terminal device communicates with the server, and is performed by cooperation between the terminal device and the server. The terminal device may be a device such as a mobile phone, a tablet computer, a notebook computer, or a desktop computer. The terminal device may further include a plurality of virtual reality (VR) devices, for example, may include an augmented reality (AR) device such as AR glasses and an AR screen, and may include a virtual reality device such as head-mounted VR glasses. The server may be understood as an application server or a Web server. In actual deployment, the server may be an independent server, a cluster server, or a cloud server.

For ease of understanding the technical solutions provided in this application, the information processing method according to this application is introduced below with reference to an actual application scenario.

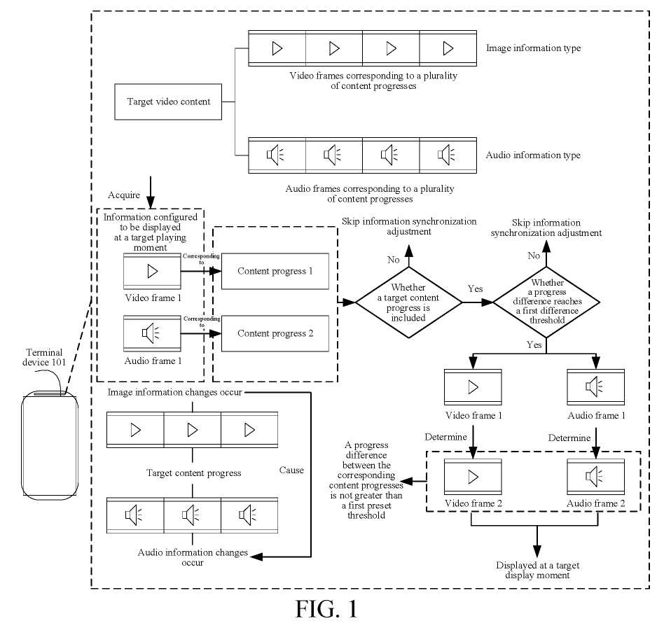

Referring to FIG. 1, FIG. 1 is a schematic diagram of an information processing method in an actual application scenario according to this application. In the actual application scenario, a computer device may be a terminal device 101 having an information processing function, for example, may be a mobile phone configured to play a video content. The content is a target video content.

The terminal device 101 may acquire a video frame and an audio frame respectively corresponding to the target video content at a plurality of content progresses. The video frame is information corresponding to an image information type in the target video content, and the audio frame is information corresponding to an audio information type in the target video content. The terminal device 101 may play the target video content by simultaneously playing the video frame and the audio frame. To normally play the target video content, at a target playing moment at which the target video content is played, the terminal device 101 first acquires a video frame 1 and an audio frame 1 configured to be played at the target playing moment. The video frame 1 is a video frame corresponding to a content progress 1, and the audio frame 1 is an audio frame corresponding to a content progress 2.

Because the video frame and the audio frame may be separately transmitted to the terminal device 101, multiple factors may occur in a transmission process, resulting in that the terminal device 101 receives information of the two information types at unsynchronized times. Consequently, the played video frame and audio frame may be unsynchronized, i.e., the content progress 1 and the content progress 2 may not be the same content progress. The terminal device 101 may perform determination of two dimensions (the two dimensions are not in a sequence), for example, may first determine whether two content progresses include a target content progress. As shown in FIG. 1, when the target video content is at the target content progress, both image information and audio information change, and the change in the image information is a reason of the change in the audio information, i.e., when the target video content is at the target content progress, the two information types both change synchronously with relatively strong correlation. For example, an event in which a person starts to make a sound occurs in the video frame, and the sound of the person synchronously appears in the audio frame.

Therefore, if a video viewing party wants to have a better viewing experience for the video content of the target content progress, it is necessary to ensure that a time interval at which the video frame and audio frame corresponding to the target content progress are played is relatively small. Based on this, if it is determined that the target content progress is not included, in this case, even if a difference in content progress occurs between the video frame and the audio frame but has a relatively small impact on the viewing experience of the video viewing party, the terminal device 101 may choose not to perform information synchronization adjustment. If the target content progress is included, the terminal device 101 may further determine whether a progress difference between the foregoing two content progresses reaches a first difference threshold. If the progress difference does not reach the first difference threshold, the two content progresses are close to each other, and directly playing the video frame 1 and the audio frame 1 has a relatively small impact on the content playing effect (for example, sound and picture synchronization) of the target content progress. Therefore, the information synchronization adjustment may not be performed. If the progress difference reaches the first difference threshold, the difference between the two content progresses is relatively large, and the video viewing party may feel a problem of significant sound and picture asynchronization when the video frame 1 and the audio frame 1 are directly played. Therefore, the terminal device 101 may perform the information synchronization adjustment, i.e., determine a video frame 2 according to the video frame 1 and determine an audio frame 2 according to the audio frame 1. A progress difference between content progresses respectively corresponding to the video frame 2 and the audio frame 2 is not greater than the first preset threshold, so that the video frame 2 and the audio frame 2 may be played at the target playing moment, so as to ensure that the video viewing party has a better video viewing experience at the target playing moment.

It can be seen from the foregoing content that when the video content is played, the terminal device 101 may not adjust each sound and picture asynchronization problem, but adjust only a sound and picture asynchronization problem greatly affecting the viewing experience of the video viewing party, and may choose not to adjust a problem having a relatively small impact, so as to ensure the video viewing experience and reduce an information adjustment amount, thereby, on one hand, reducing an information amount of loss and deformation due to information synchronization adjustment, and improving the integrity and fidelity of video viewing, and on the other hand, reducing the time required for information synchronization adjustment, and being conducive to bringing a more real-time video viewing experience in real-time video transmission scenarios.

Next, an information processing method according to this application is introduced with reference to the accompanying drawings.

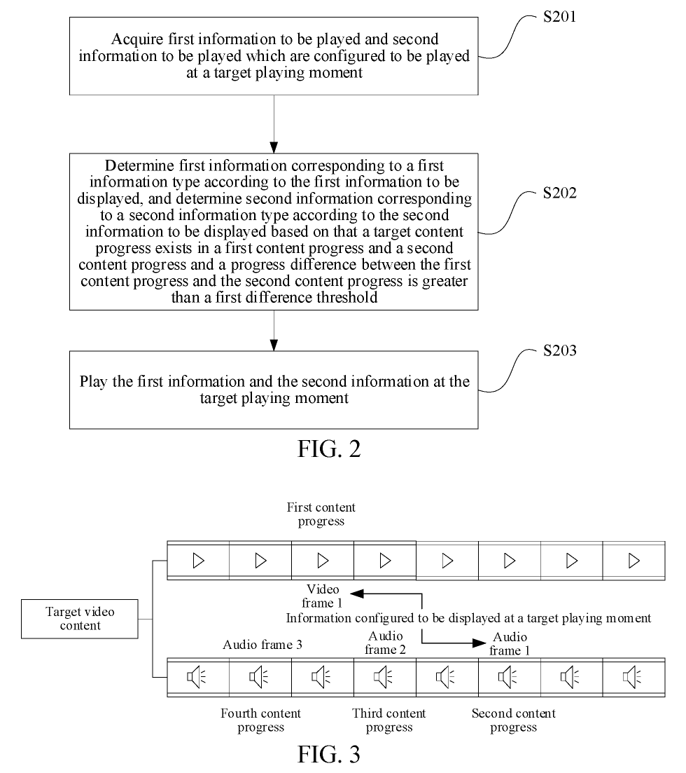

Referring to FIG. 2, FIG. 2 is a flowchart of an information processing method according to an embodiment of this application. In this embodiment, the computer device may be any foregoing computer device having an information processing capability, for example, may be a terminal device configured to process and play information. The method includes:

S201: Acquire first information to be played and second information to be played which are configured to be played at a target playing moment.

The first information to be played and the second information to be played are information played at the target playing moment if information synchronization adjustment does not need to be performed. For information of a plurality of information types that needs to be originally played at the same playing moment (for example, a target playing moment), the information synchronization adjustment is configured to reduce a progress difference between content progresses respectively corresponding to the information.

The information of the plurality of information types includes at least the foregoing first information to be played and second information to be played. The first information to be played is of a first information type and corresponds to a first content progress of a target content. The second information to be played is of a second information type and corresponds to a second content progress of the target content. The first information type and the second information type are different information types, i.e., the target content includes information of a plurality of information types, and the information of the plurality of information types jointly constitutes the target content. Therefore, at the same content progress of the target content, there are information of the plurality of information types.

The content progress refers to a corresponding progress of the information in the target content, and can identify time sequence distribution of the information in the target content. The content progress may be specifically indicated by a time. For example, a total playing duration of the target content is 1 minute. The content progress may be expressed in a form of a moment, such as the 5^{th} second and the 18^{th} second, or may be expressed in a form of a percentage, such as 10% (corresponding to the 6^{th} second) or 50% (corresponding to the 30^{th} second).

The playing moment is configured for identifying a moment at which the target content is played, and may be understood as a moment expression form of a content progress. The target content may be a plurality of types of content. Taking a video content as an example, a plurality of information types corresponding to the video content may include an image information type and an audio information type, i.e., "picture" and "sound" in audio-picture synchronization. Information of the image information type corresponding to the video content may be image information (for example, a video frame), information of the audio information type corresponding to the video content may be audio information (for example, an audio frame), and the content progress may be the time corresponding to information in the video content, for example, the i^{th} second or i^{th} frame in the video content.

S202: Determine first information corresponding to the first information type according to the first information to be played, and determine second information corresponding to the second information type according to the second information to be played based on that a target content progress exists in the first content progress and the second content progress and a progress difference between the first content progress and the second content progress is greater than a first difference threshold.

The target content usually has an association between information corresponding to a plurality of information types. For example, an event of a video content occurring in image information has a corresponding sound in audio information. Therefore, to enable the content browsing party receiving and playing the target content to have good content browsing experience, when the information of a plurality of information types is played, it usually needs to ensure that content progresses respectively corresponding to the information of the plurality of information types are relatively close.

The difference lies in that it is found in this application that not all content progress differences between information can be significantly perceived by the content browsing party. For example, in a video content, if image information keeps a black screen in a period of time, and even if sound information changes, the content browsing party cannot significantly perceive whether a sound change time is accurate, and therefore cannot significantly perceive the problem of sound and picture asynchronization. However, if the image information is a picture in which a person starts to make a sound, but no sound made by the person appears in the audio information, the content browsing party can significantly perceive that the problem of sound and picture asynchronization occurs.

Based on this, to reduce an adjustment amount of information synchronization adjustment while ensuring the content browsing experience, the computer device may only adjust the problem of information asynchronization that can be significantly perceived by the content browsing party. The computer device may perform analysis in two dimensions. The first dimension is to analyze whether the target content progress exists in the first content progress and the second content progress. The information respectively corresponding to the first information type and the second information type both changes when the target content is at the target content progress, and an information change in the first information type is a reason of an information change in the second information type, i.e., when the target content is at the target content progress, information changes in a plurality of information types, and an association between information changes in the plurality of information types is relatively close, so that the content browsing party can significantly perceive that when the target content is played to the target content progress, whether the information of the plurality of information types is correctly and synchronously played. For example, that a person in the image information starts to make a sound is a reason why a person sound appears in the audio information, and that a door is closed in the image information is a reason why a door closing sound appears in the audio information.

Therefore, in the first dimension, if the computer device determines that the first content progress and the second content progress include the target content progress, the difference between the two content progresses (i.e., the association between the first information to be played and the second information to be played) has a relatively large impact on the content browsing experience. If the target content progress is not included, the difference between the two content progresses has a relatively small impact on the content browsing experience.

In the second dimension, the computer device may determine whether the progress difference between the first content progress and the second content progress is greater than the first difference threshold. The first difference threshold is configured for determining whether there is a relatively large difference between the two content progresses. If the progress difference is greater than the first difference threshold and the target content progress is included, in this case, if the first information to be played and the second information to be played are directly played, the difference between the content progresses has a relatively large impact on the content browsing experience. In this case, the computer device may perform the information synchronization adjustment. If the target content progress is not included, or the content progress is included but the difference between the content progresses does not exceed the first difference threshold, the difference between the two content progresses has a relatively small impact on the content browsing experience, and the computer device may choose not to perform the information synchronization adjustment, thereby reducing an information adjustment amount.

When the information synchronization adjustment is performed, the computer device may determine the first information according to the first information to be played, and determine the second information according to the second information to be played. There may be a plurality of determining modes which are introduced in detail below. The difference between the content progresses respectively corresponding to the first information and the second information in the target content is not greater than the first difference threshold, so as to ensure that when the first information and the second information are played at the target playing moment, good information synchronization can be achieved, and the impact on the content browsing experience is relatively small.

S203: Play the first information and the second information at the target playing moment.

It can be seen from the foregoing technical solution that in this application, after the first information to be played and the second information to be played which are configured to be played at the target playing moment, are acquired, instead of directly playing the first information to be played and the second information to be played at the target playing moment, a content progress difference between the two pieces of information to be played is first analyzed, whether the content progresses corresponding to the two pieces of information to be played include the target content progress greatly affecting the content browsing experience is analyzed, and targeted information synchronization adjustment is performed on a plurality of pieces of information including the target content progress and having a relatively large progress difference. In this application, when the information synchronization adjustment is performed, only the information that has a progress difference and greatly affects the content browsing experience is adjusted, and the information that needs to be played at each moment when the progress difference exists does not need to be adjusted. Therefore, the content browsing experience is ensured, and an adjustment amount of the information synchronization adjustment is reduced, thereby reducing an amount of information that needs to be discarded, prolonged/slowly played, or processed otherwise during the information synchronization adjustment, helping the content browsing party to browse more complete and authentic content during content browsing, and also reducing the information processing duration. This application is more applicable to scenarios having relatively high real-time requirements for content playing.

As described above, if the target content progress does not exist in the first content progress and the second content progress, the difference between the content progresses does not easily affect the content browsing experience, but it does not mean that the content browsing experience is not affected at all. If the difference between the two content progresses is excessively large, the content browsing party may still perceive the problem of information asynchronization. For example, in a video content, if a time difference between audio information and image information is excessively large, although the video content may have no content that can cause a significant information change, the video viewing party may still perceive sound and picture asynchronization.

Based on this, in a possible implementation, to further improve the content browsing experience, the computer device may further determine whether the progress difference between the first content progress and the second content progress is greater than a second difference threshold. The second difference threshold is greater than the first difference threshold, i.e., for information that does not include the target content progress, a threshold for the computer device to trigger the information synchronization adjustment is increased, i.e., only a relatively large progress difference triggers the information synchronization adjustment, so as to provide a relatively large progress difference space for information that has a relatively small impact on the content browsing experience, and reduce an information adjustment amount to some extent.

Based on that the target content progress does not exist in the first content progress and the second content progress and the progress difference between the first content progress and the second content progress is greater than the second difference threshold, because the difference between content progresses respectively corresponding to the first information to be played and the second information to be played is excessively large, simultaneously playing the first information to be played and the second information to be played still easily affects the content browsing experience. In this case, the computer device may determine third information corresponding to the first information type according to the first information to be played and determine fourth information corresponding to the second information type according to the second information to be played, and then play the third information and the fourth information at the target playing moment, where a difference between content progresses respectively corresponding to the third information and the fourth information in the target content is not greater than the second difference threshold, thereby implementing the information synchronization adjustment for the moment at which the information is played.

Similarly, based on that the progress difference between the first content progress and the second content progress is not greater than the first difference threshold, the content progress difference between the two pieces of information is relatively small. Regardless of whether the information is easy to be perceived as synchronized, under the progress difference, it is difficult for the content browsing party to perceive the problem of information asynchronization. Therefore, the computer device may directly play the first information to be played and the second information to be played at the target playing moment.

Alternatively, based on that the progress difference between the first content progress and the second content progress is not greater than the second difference threshold and a target content progress does not exist in the first content progress and the second content progress, although there is a certain difference between the content progresses of the two pieces of information, it is not easy to perceive whether the problem of information synchronization occurs for the information itself. Therefore, after playing, it is difficult for the content browsing party to perceive the problem of information asynchronization. Therefore, the computer device may directly play the first information to be played and the second information to be played at the target playing moment. In the foregoing mode, cases in which the information synchronization adjustment needs to be performed can be reduced to some extent, so that the information adjustment amount can be reduced.

Next, the information synchronization adjustment process is introduced in detail.

First, when the information synchronization adjustment is performed, the information that needs to be adjusted may be different according to different adjustment requirements. Next, descriptions are provided mainly based on two modes: adjustment is performed on information of a single information type and adjustment is performed with reference to information of two information types.

First mode: Adjustment is performed on information of a single information type.

The information is usually played in sequence based on content progresses. Therefore, to ensure continuity of information playing on one hand, and to reduce an adjustment calculation amount of information synchronization adjustment on the other hand, the computer device may adjust information of only a single information type in the two information types, and keep information of the other information type unchanged.

In a possible implementation, when performing operation S202, the computer device may perform operation S2021 (not shown in the figure), and operation S2021 is a possible implementation of operation S202, including:

S2021: Determine the first information to be played as first information corresponding to the first information type, and determine second information corresponding to the second information type according to the second information to be played.

The computer device may keep the first information to be played of the first information type unchanged, and perform information synchronization adjustment on the second information to be played of the second information type, so as to acquire the second information. The second information is configured for simulating the information corresponding to the second information type of the target content at a third content progress. A progress difference between the third content progress and the first content progress is not greater than the first difference threshold, so that a relatively small content progress difference can be brought when the first information (i.e., the first information to be played) and the second information are played at the target playing moment, thereby ensuring the content viewing experience of the content browsing party.

The simulation in this application may be the information corresponding to the second information type of the target content at the third content progress, or may be information similar to the information. For example, when the information synchronization adjustment is performed on an image information type, image information corresponding to the target content at the third content progress may be directly selected as the second information. When the information synchronization adjustment is performed on an audio information type, adjustments such as audio slow playing and compression may be performed on the second information to be played, so as to acquire the second information similar to the audio information corresponding to the target content at the third content progress.

To further reduce the information adjustment amount of information synchronization adjustment, in a possible implementation, the third content progress may be located between the first content progress and the second content progress, so that the difference between the third content progress and the second content progress can be reduced. When the second information is determined according to the second information to be played, an adjustment amount of the information can be reduced. For example, when the second information can be played at the target playing moment by deleting the information corresponding to the content progress between the second content progress and the third content progress, a deletion amount of the information can be reduced, so that the content browsed by the content browsing party can be more complete. When the second information is acquired by performing information deformation processing such as lengthening or shortening an audio frame on the second information to be played, an information deformation amplitude of the second information to be played can be reduced, so that the second information can be more real and authentic.

As shown in FIG. 3, the information for playing at the target playing moment is a video frame 1 and an audio frame 1, and the first difference threshold may be one frame. The progress difference between the first content progress and the second content progress is three frames, and therefore exceeds the first progress difference. If the target content progress is included, information synchronization adjustment needs to be performed. The computer device may keep the video frame 1 unchanged, and adjust the audio frame. The difference between the content progresses corresponding to an audio frame 3 and an audio frame 2 and the first content progress is respectively one frame, satisfying an adjustment requirement. However, the progress difference between the second content progress and a fourth content progress is much greater than the progress difference between the second content progress and the third content progress. Therefore, an information processing amount required by adjustment to the audio frame 3 is larger. Therefore, the audio frame 2 may be selected as an actually played audio frame.

In addition, to further reduce the impact of the information synchronization adjustment on the content browsing experience, the computer device may further analyze the impact on the content browsing experience caused by the information synchronization adjustment of each information type, so as to select information of an information type having a relatively low impact to perform the information synchronization adjustment.

For example, in a possible implementation, the second information type is an audio information type, and a change mode of the audio information in a time domain is a key factor for determining whether the audio information perceived by the content browsing party is distorted. Therefore, when the audio information is adjusted, if the time difference between the audio information before the adjustment and the audio information after the adjustment is relatively large, for example, the audio information in a relatively long time period is compressed to acquire new audio information, the audio information perceived by the content browsing party is easily distorted.

Based on this, in a possible implementation, the computer device may determine whether to use an audio information type as an information type that needs to be adjusted according to a content progress interval that needs to be adjusted. When performing operation S2021, the computer device may perform operation S20211 (not shown in the figure), and operation S20211 is a possible implementation of operation S2021, including:

S20211: Determine the first information to be played as first information corresponding to the first information type based on that the progress difference between the second content progress and the first content progress is less than a third difference threshold, and determine second information corresponding to the second information type according to the second information to be played.

The third difference threshold is configured for measuring whether the difference between the two content progresses is relatively small. If the progress difference between the two content progresses is less than the third difference threshold, adjusting the audio information according to the progress difference has a relatively low probability of causing distortion of the audio information. Therefore, the audio information type may be used as an information type for information synchronization adjustment. Otherwise, the probability of causing distortion of the audio information is relatively large, and the computer device may select other information types for adjustment.

Specific adjustment modes for the audio information may include the following several modes:

When the audio information precedes the information of another information type in content progress (for example, the audio information reaches the 10^{th} second of the content, but the information of another information type reaches only the 8^{th} second), the computer device may reduce a playing speed of the audio information by a time stretching (TS) algorithm to wait for arrival of the information of another information type. If the information of another information type precedes the audio information in content progress, the playing speed of the audio information may be increased by the time stretching algorithm to catch up with the content progress of the information of another information type.

In another possible implementation, the computer device may further determine whether to select an image information type as a type for information synchronization adjustment based on the adjustment impact of the image information. In some contents, the image information corresponding to a plurality of content progresses may be relatively similar. For example, the video content may include some contents that are static in image information. When the part of image information is fast-forwarded or slow-played, it is difficult for the content browsing party to perceive that the image information is adjusted. Therefore, the perceived intensity for information synchronization adjustment is relatively small.

Based on this, in a possible implementation, to reduce the impact of the information synchronization adjustment on the content browsing experience, the computer device may perform the information synchronization adjustment only on the image information having a relatively small change amplitude. In this implementation, the second information type may be an image information type. When performing operation S2021, the computer device may perform operation S20212 (not shown in the figure), and operation S20212 is a possible implementation of operation S2021, including:

S20212: Determine the first information to be played as first information corresponding to the first information type based on that the target content is between the second content progress and the third content progress and an information change amplitude of information corresponding to the image information type is less than an amplitude threshold, and determine second information corresponding to the second information type according to the second information to be played.

The amplitude threshold is configured for measuring an image information change amplitude between a plurality of content progresses. If the image information change amplitude is less than the amplitude threshold, the image information change amplitude is relatively small between the second content progress and the third content progress. Therefore, when the image information corresponding to the second content progress is adjusted to the image information corresponding to the third content progress, the perceived intensity of the content browsing party for the adjustment is relatively small, and the content viewing experience is better. Therefore, the computer device may use the image information type as an information type for information synchronization adjustment. If the image information change amplitude is not less than the amplitude threshold, the image information change amplitude is relatively large between the second content progress and the third content progress. Therefore, if the image information played at the target playing moment is directly changed from the second information to be played to the second information, the content browsing party will perceive an abnormal image information change probably, affecting the content browsing experience of the content browsing party.

When adjusting the image information, the computer device may use the following adjustment mode:

When the image information precedes the information of another information type in content progress (for example, the image information reaches the 10^{th} second of the content, but the information of another information type reaches only the 8^{th} second), the computer device may slow down the playing of the image information, or keep the image information unchanged (for example, adding a static frame), so as to wait for the information of another information type to catch up. When the image information lags behind the information of another information type in content progress, the computer device may delete the image information corresponding to a part of the content progress, so that the playing of the image information catches up with the information of another information type. For example, when the image information reaches the 8^{th} second of the content and the information of another information type reaches the 10^{th} second of the content, the computer device may delete the image information before the 10^{th} second, and directly play the image information of the 10^{th} second.

Second mode: Adjustment is performed with reference to information of two information types.

The objective of the information synchronization adjustment is to reduce the content progress difference between actually played information of two information types. Therefore, generally, an adjustment amplitude of the content progress difference is undertaken by the information of the two information types. Compared with adjusting information of only one information type, an adjustment amplitude of the information of each information type can be controlled to a relatively low amplitude, thereby ensuring the content browsing experience. For example, the difference between content progresses of two pieces of information may be 10 s. If the information of a single information type is adjusted to be fast-forwarded or slow-played for 10 s, a poor content browsing experience may be brought due to an excessively large adjustment amplitude. However, if the information of two information types is respectively adjusted for 5 s, an overall adjustment amplitude may be reduced to reduce the impact of the information synchronization adjustment on the content browsing experience.

Based on this, in a possible implementation, the first information acquired through the information synchronization adjustment may be configured for simulating the information corresponding to the first information type of the target content at the fourth content progress, and the second information may be configured for simulating the information corresponding to the second information type of the target content at the fifth content progress. The fourth content progress and a fifth content progress are located between the first content progress and the second content progress, so that an adjustment amplitude can be divided into two information types, thereby further reducing the impact of the information synchronization adjustment on the content browsing experience.

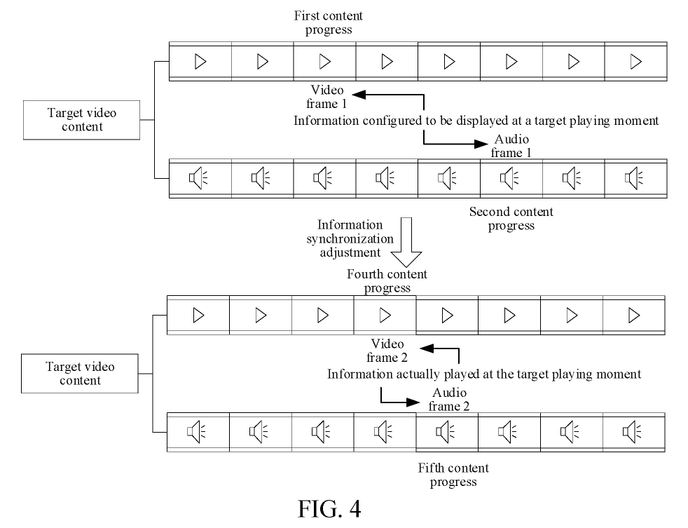

As shown in FIG. 4, before adjustment, a video frame 1 and an audio frame 1 configured to be played at a target playing moment have a content progress difference of 3 frames. During information synchronization adjustment, only 1 frame needs to be adjusted in an image information type and 1 frame needs to be adjusted in an audio information type, so as to acquire a video frame 2 and an audio frame 2. The content progress difference between the video frame 2 and the audio frame 2 is only 1 frame satisfying a playing requirement, and the video frame and the audio frame can be actually played at the target playing moment.

The solution in this application is only introduced for two information types related to the content, and can also be applied to the content having two or more information types. This is not limited here.

Next, how to determine the target content progress corresponding to the target content is introduced in detail.

As described above, the information of the target content changes in the target content progress. This is also a reason why the information corresponding to the target content progress greatly affects the content browsing experience. Based on this, in a possible implementation, the computer device may analyze whether there is the foregoing target content progress based on information changes of the information at each content progress.

In this implementation, the target content progress is determined by a progress determining process, the progress determining process including:

the computer device may acquire first information to be analyzed and second information to be analyzed, respectively corresponding to the first information type, of the target content at a sixth content progress and a seventh content progress, and a progress difference between the seventh content progress and the sixth content progress is less than a fourth difference threshold, i.e., the seventh content progress is a content progress relatively close to the sixth content progress, and the sixth content progress may be any content progress in the target content. Because the target content progress satisfies corresponding information changes in two information types, the computer device may perform information change detection for a single information type, so as to determine the target content progress in the target content. The computer device may preset a first information difference threshold. The first information difference threshold is configured for measuring whether a significant change occurs in information. Based on that the difference between the first information to be analyzed and the second information to be analyzed is greater than the first information difference threshold, a relatively significant information change occurs in information of at least the first information type when the target content is at the sixth content progress. Therefore, the computer device may determine the sixth content progress as the target content progress.

A plurality of target content progresses determined in this mode may not all satisfy information changes in the two information types. For example, content progresses only significantly changing in the first information type may also be identified in this mode, but a target content progress satisfying the foregoing requirement may be determined in this mode. Therefore, when the information synchronization adjustment is performed on the target content progress determined in this mode, the technical effects related to this application can still be brought.

The seventh content progress may be before the sixth content progress, or may be after the sixth content progress. When the seventh content progress is before the sixth content progress, the sixth content progress is highly probably a start progress of a certain key content. When the seventh content progress is after the sixth content progress, the sixth content progress is highly probably an end progress of a certain key content. The computer device may perform the information synchronization adjustment on the two progresses, so as to improve the information synchronization of playing of the key content.

Information change analysis situations for different information types may be different. A plurality of information types are introduced in detail below.

In a possible implementation, the first information type may be an audio information type, the first information difference threshold includes a first energy threshold, and the first energy threshold is configured for measuring whether the information energy of two pieces of audio information has a relatively large difference. The first information to be analyzed is first audio information, and the second information to be analyzed is second audio information. When determining the sixth content progress as the target content progress based on that the difference between the first information to be analyzed and the second information to be analyzed is greater than the first information difference threshold, the computer device may analyze whether the difference between the information energy of the two pieces of audio information reaches the first energy threshold.

Based on that information energy of the first audio information exceeding the second audio information reaches the first energy threshold, the audio information greatly changes in the sixth content progress. Therefore, the sixth content progress may be determined as the target content progress. For example, when special events such as door closing and exploding occur in a video content, special sounds such as a door closing sound and an explosive sound occur in audio information. Consequently, the audio information changes significantly. Usually, the content browsing party is relatively sensitive to a change in audio information. Therefore, in this mode, the content that is easy to be perceived by the content browsing party may be determined, so as to determine the target content progress.

In addition, for the audio information, the computer device may further analyze whether the audio information can be perceived by the content browsing party. For example, the computer device may set a preset perceptual threshold according to the information energy that can be perceived by the content browsing party. The audio information can be perceived by the content browsing party only when the information energy is greater than the preset perceptual threshold. Therefore, based on determining the information energy difference of the audio information, the computer device may further determine with reference to the preset perceptual threshold. Only when the information energy difference reaches the first energy threshold and the first audio information exceeds the preset perceptual threshold, the computer device may determine that an audio information change of the content progress may be perceived by the content browsing party, and therefore may be determined as the target content progress. On the contrary, if the first audio information does not exceed the preset perceptual threshold, even if an information energy change occurs, the information energy change cannot be perceived by the content browsing party. Therefore, the impact on the content browsing experience is relatively small.

The content browsing party has different perceptual sharpness for different audio information, and meanwhile, the synchronization of information changes of different audio information has different impacts on the content browsing experience. For example, when a person makes a sound, the content browsing party is usually relatively sensitive to the synchronization on audio information and image information, a relatively small content progress difference that occurs can be clearly perceived, and the sensibility to synchronization perception of an object collision or an object sound effect is relatively low. Based on this, in a possible implementation, the computer device may perform more accurate information change identification on the human voice information.

A process of sounding of a person includes a human voice start event (i.e., the person starts sounding) and a human voice end event (i.e., the person ends sounding). First, in a possible implementation, the computer device may accurately identify the human voice start event, so as to determine a content progress at which the person starts sounding. In this implementation, the sixth content progress is after the seventh content progress, the first information difference threshold further includes a second energy threshold, and the progress determining process further includes:

The computer device may further analyze whether the first audio information and the second audio information include human voice information. Based on that the information energy of the first audio information exceeding the second audio information reaches the second energy threshold and the first audio information includes the human voice information and the second audio information does not include the human voice information, the person does not make a sound before the sixth content progress, the person starts to make a sound at the sixth content progress, a human voice start event occurs, and the human voice start event can be relatively clearly perceived by the content browsing party. Based on this, the computer device may determine the sixth content progress as the target content progress. The second energy threshold is less than the first energy threshold. Therefore, the difference between audio information including the human voice information can be identified more accurately, so as to satisfy a requirement of the content browsing party for high information synchronization of the human voice information.

In another possible implementation, the computer device may accurately identify a human voice end event. The sixth content progress is after the seventh content progress, the first information difference threshold further includes a second energy threshold, and the progress determining process further includes:

Based on that the information energy of the first audio information lower than the second audio information reaches the second energy threshold and the second audio information includes the human voice information and the first audio information does not include the human voice information, the person is still sounding at the seventh content progress, and the person already ends sounding at the sixth content progress. Therefore, it may indicate that a human voice end event highly probably occurs at the sixth content progress, so that the computer device may determine the sixth content progress as the target content progress. The second energy threshold is less than the first energy threshold.

By means of the foregoing process, the computer device may perform more accurate content identification on content progresses of starting and ending of human voice, so as to ensure that the content browsing party may perceive the content of person sounding with relatively strong information synchronization, thereby satisfying a requirement of the content browsing party for high synchronization perception of the person sounding content. The second energy threshold for identifying the human voice start event and the human voice end event may be different, or may be the same threshold. This is not limited here.

In another possible implementation, the first information type is an image information type, the first information difference threshold may include an image information difference threshold, the first information to be analyzed is first image information, and the second information to be analyzed is second image information. When determining the sixth content progress as the target content progress based on that the difference between the first information to be analyzed and the second information to be analyzed is greater than the first information difference threshold, the computer device may analyze whether the difference between the first image information and the second image information reaches the image information difference threshold. The image information difference threshold is configured for measuring whether the two pieces of image information have a relatively large difference that can be clearly perceived by the content browsing party. Based on that the difference between the first image information and the second image information reaches the image information difference threshold, a relatively significant change occurs in the image information type at the sixth content progress, and the sixth content progress is highly probably the target content progress. Therefore, the computer device may determine the sixth content progress as the target content progress, so as to ensure information synchronization perception of the content browsing party on a change of the image information.

Similar to the human voice information, a person image is generally perceived relatively sharply by the content browsing party. Therefore, the computer device may set a relatively low image information difference threshold to perform a higher level of identification for the content progress of appearance or disappearance of the person image. For example, if the sixth content progress is after the seventh content progress, the seventh content progress does not include the person image, the sixth content progress includes the person image, and the image information difference is greater than a relatively low image information difference threshold, a person appearance event that is easily perceived occurs at the sixth content progress, and the computer device may determine the sixth content progress as the target content progress. If the sixth content progress is after the seventh content progress, the seventh content progress includes the person image, the sixth content progress does not include the person image, and the image information difference is greater than a relatively low image information difference threshold, a person disappearance event that is easily perceived occurs at the sixth content progress, and the computer device may also determine the sixth content progress as the target content progress.

Further, as described above, the target content progress has information changes in the two information types, and information synchronization changes of a plurality of information types are also reasons of why the content browsing party easily perceives whether the information is synchronized. Therefore, in a possible implementation, to further improve the identification accuracy of the target content progress, so as to reduce an amount of information synchronization adjustment during information playing, the computer device may perform information change analysis on the information of the two information types at the same time.

In this implementation, the progress determining process may further include:

acquiring third information to be analyzed and fourth information to be analyzed, respectively corresponding to the second information type, of the target content at the sixth content progress and the seventh content progress. When determining the sixth content progress as the target content progress based on that the difference between the first information to be analyzed and the second information to be analyzed is greater than the first information difference threshold, the computer device may preset a second information difference threshold, and further analyze the information difference between the third information to be analyzed and the fourth information to be analyzed. The second information difference threshold is configured for measuring whether the information in the second information type has an information change that is easily perceived by the content browsing party.

Based on that the difference between the first information to be analyzed and the second information to be analyzed is greater than the first information difference threshold and the difference between the third information to be analyzed and the fourth information to be analyzed is greater than the second information difference threshold, at the sixth content progress, the target content has a relatively significant change that can be perceived by the content browsing party in both the first information type and the second information type. Therefore, the sixth content progress is highly probably the target content progress. Therefore, the computer device may determine the sixth content progress as the target content progress, so as to perform the information synchronization adjustment for the sixth content progress during information playing.

Compared with the foregoing mode of identifying the target content progress based on an information change of a single information type, the target content progress identified with reference to information changes of a plurality of information types is more accurate, and some content progresses in which an information change occurs only in a single information type can be removed, thereby reducing the number of content progresses that need to be adjusted in an information playing process. On the premise that the content browsing experience is ensured, an information adjustment amount is further reduced, thereby being conducive to improving the integrity and fidelity of the played content.

In addition to directly identifying the target content progress from a dimension of the information change, in another possible implementation, the computer device may further directly determine the target content progress related to the target content by means of content identification.

The existence of some specific contents easily causes information changes in a plurality of information types, and an association between information changes in the plurality of information types is relatively strong. For example, in a content related to person speaking, changes in a mouth shape or action of the person appear in image information, and human voice information appears in audio information. In a content related to object explosion, an image effect of object explosion appears in the image information, and an explosion sound appears in the audio information. The content is a content in which the content browsing party can accurately perceive whether the problem of information synchronization occurs in content playing. Based on this, the computer device may directly identify the part of content to determine the content progress related to the part of content, and determine the content progress as the target content progress, so that relatively accurate information synchronization adjustment is performed on the part of content during information playing, thereby ensuring the content browsing experience.

In this implementation, the progress determining process may include:

acquiring the information to be analyzed, corresponding to the target information type, of the target content at an eighth content progress. The eighth content progress may be any content progress related to the target content, and the target information type is the first information type or the second information type. The computer device may predetermine the information respectively corresponding to the target information type of a target sub-content, and this part of information is referred to as content identification information, i.e., if the information corresponding to the target information type of the target content at a certain content progress includes the content identification information, the target content highly probably has the target sub-content at the content progress. The target sub-content is a content causing an information change in the first information type and the second information type, and an information change in the first information type is a reason of an information change in the second information type, i.e., the target sub-content is the foregoing content in which the content browsing party easily perceives whether an information synchronization difference occurs.

Therefore, based on that the information to be analyzed includes the content identification information corresponding to the target information type, the computer device may determine that a content related to the eighth content progress is easily perceived by the content browsing party to determine whether an information synchronization difference occurs, so that the computer device may determine the eighth content progress as the target content progress, and the content identification information is information corresponding to the target information type of the target sub-content. Therefore, during information playing, by means of information synchronization adjustment for the target content progress, the computer device can ensure relatively strong information synchronization when the target sub-content is played.

For example, the target sub-content may be a content of object explosion, the content identification information corresponding to the image information type may be a picture of object explosion, and the content identification information corresponding to the audio information type may be a sound of object explosion. As long as it is identified that the image information corresponding to the eighth content progress includes a picture of object explosion, or the audio information corresponding to the eighth content progress includes a sound of object explosion, it can be determined that the content of object explosion occurs at the eighth content progress. Therefore, the computer device may determine the eighth content progress as the target content progress.

To enable the determined target content progress to be adjusted in a targeted mode in each device on the information playing side, the computer device may add a corresponding identifier for the target content progress. In a possible implementation, the progress determining process further includes:

Based on determining the sixth content progress as the target content progress, the computer device may add the target identifier to the first information to be analyzed and the third information to be analyzed. The third information to be analyzed is information corresponding to the second information type of the target content at the sixth content progress, i.e., the computer device may add the target identifier to the information corresponding to each information type of the target content at the target content progress. The target identifier is configured for identifying the target content progress corresponding to the information.

Therefore, when performing operation S202, the computer device may perform operation S2022 (not shown in the figure), and operation S2022 is a possible implementation of operation S202, including:

S2022: Determine first information corresponding to the first information type according to the first information to be played, and determine second information corresponding to the second information type according to the second information to be played based on that information including the target identifier exists in the first information to be played and the second information to be played and a progress difference between the first content progress and the second content progress is greater than a first difference threshold.

The computer device may determine whether the content progress corresponding to the information to be played includes the target content progress according to whether the information to be played includes the target identifier. Therefore, the progress determining process only needs to be performed once, and the target content progress of the target content can be accurately identified in a plurality of computer devices for information processing. On one hand, the information of the target content does not need to be analyzed for a plurality of times. On the other hand, the identification based on the target identifier is relatively simple, and the information processing efficiency can be further improved.

The computer device for performing the progress identification process and the computer device for performing information processing and playing may be different computer devices. For example, in a possible implementation, the foregoing information processing method may be applied to a first device on an information playing side. The first device is configured to perform information synchronization processing and information playing. The progress determining process is performed by a second device on an information transmitting side. The second device is configured to transmit the information respectively corresponding to the first information type and the second information type of the target content to the first device. For example, after acquiring the target content, the second device first determines the target content progress included in the target content, adds the target identifier to the information related to the target content progress, and then respectively transmits the information of the first information type and the information of the second information type corresponding to the target content to the first device, and the first device may play the received information of each information type in sequence. Because various interference factors may occur in an information transmission process, a progress of receiving information by the first device is different from a progress of transmitting information by the first device, which may cause a content progress difference when the first device plays information. The first device may determine the information related to the target progress content by the target identifier added by the second device, and perform information synchronization adjustment on this part of information, so as to ensure the content browsing experience.

For ease of understanding the technical solutions provided in this application, the information processing method according to this application is introduced below with reference to an actual application scenario.

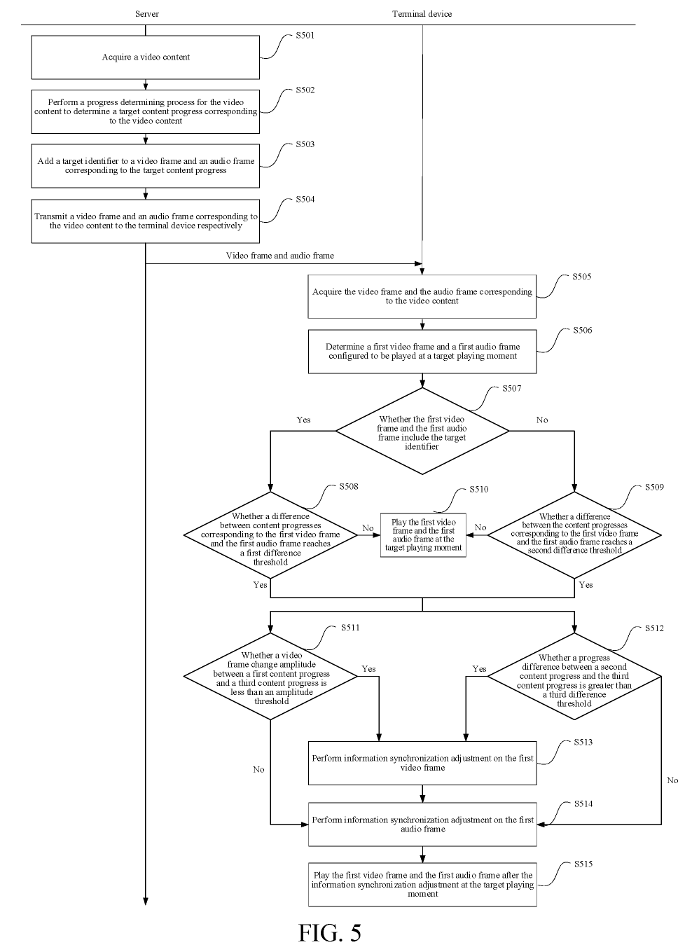

Referring to FIG. 5, FIG. 5 is a signaling diagram of an information processing method in an actual application scenario according to this application. In the actual application scenario, the computer device may include a terminal device on an information playing side and a server on an information transmitting side. The content may be a video content. An information type corresponding to the video content includes an image information type and an audio information type. The information corresponding to the image information type of the video content is a video frame. The information corresponding to the audio information type of the video content is an audio frame. The content progress is a corresponding frame position of the video frame or audio frame in the video content (such as the frame number). The method includes:

S501: The server acquires the video content.

The video content may be any video content, for example, may be a video content in real-time video communication.

S502: The server performs a progress determining process for the video content to determine a target content progress corresponding to the video content.

The server may enable the video content to respectively pass through a video encoder and an audio encoder, so as to acquire a video encoding stream and an audio encoding stream. The video encoding stream includes a plurality of video frames, and the audio encoding stream includes a plurality of audio frames. The server may analyze information changes in the video frame and the audio frame, so as to determine the target content progress.

For example, the server may determine whether there is a sudden change in audio energy in the audio frame, i.e., a frame energy transient event, such as a door closing sound or a knock sound. If the energy of the current audio frame is greater than the preset perceptual threshold (a frame energy value that reaches a significant level according to human ear perception), or the energy of the current audio frame is greater than the energy of a previous frame by M1 or more times (M1 is an empirical value, for example, M1=10).

Alternatively, the server may determine whether there is a sound start event or a sound end event according to an audio frame. The event needs to be subjected to third-level detection. The first-level detection is human voice detection (which may be implemented by an existing voice activity detection (vad) algorithm or a human voice detection algorithm based on a deep neural network), and is configured to detect whether the current audio frame has human voice information. If the detection result indicates that the current audio frame has human voice information, second-level detection is performed, i.e., whether the information energy of the current frame exceeds a preset perceptual threshold is detected. If the detection result is true, third-level detection, i.e., human voice start and end detection, is performed If the audio signal of the previous frame or the frame before the previous frame does not include human voice information, the audio signal of the current frame includes human voice information, and the energy of the current frame exceeds the energy of the previous frame or a non-human voice frame before the previous frame by M2 or more times (M2 is an empirical value, for example, M2=8, and is less than M1), it is determined that a human voice start event occurs in the current frame. If the audio signal of the previous frame includes human voice information, the audio signal of the current frame does not include human voice information, and the energy of the previous frame exceeds the energy of the current frame by M3 or more times (M3 is an empirical value, for example, M3=5, and is also less than M1), a human voice end event occurs in the current frame, and the corresponding content progress may also be determined as the target content progress.

S503: The server adds a target identifier to the video frame and audio frame corresponding to the target content progress.

The server may add a "1" identifier (i.e., a target identifier) to the video frame and audio frame corresponding to the target content progress, and add a "0" identifier to the video frame and audio frame corresponding to the non-target content progress.

S504: The server transmits the video frame and audio frame corresponding to the video content to the terminal device respectively.

S505: The terminal device acquires the video frame and audio frame corresponding to the video content.

S506: The terminal device determines a first video frame and a first audio frame configured to be played at a target playing moment.

The first video frame corresponds to the first content progress, and the second video frame corresponds to the second content progress.

S507: The terminal device determines whether the first video frame and the first audio frame include the target identifier.

The terminal device may determine whether the identifier included in the first video frame and the first audio frame is the identifier "1" or the identifier "0", so as to determine whether the identifier corresponds to the target content progress.

S508: The terminal device determines whether a difference between content progresses corresponding to the first video frame and the first audio frame reaches a first difference threshold.

If the identifier "1" is included, the first video frame and the first audio frame have information corresponding to the target content progress. In this case, the computer device may determine whether the difference between the content progresses corresponding to the first video frame and the first audio frame reaches a relatively small first difference threshold. If yes, information synchronization processing is performed. If not, operation S510 may be performed.

S509: The terminal device determines whether a difference between the content progresses corresponding to the first video frame and the first audio frame reaches a second difference threshold.

If the identifier "1" is not included, the first video frame and the first audio frame do not have information corresponding to the target content progress. In this case, the computer device may determine whether the difference between the content progresses corresponding to the first video frame and the first audio frame reaches a relatively large second difference threshold. If yes, information synchronization processing is performed. If not, operation S510 may be performed.

S510: The terminal device plays the first video frame and the first audio frame at the target playing moment.

S511: The terminal device determines whether a video frame change amplitude between the first content progress and the third content progress is less than an amplitude threshold.

During information synchronization adjustment, the computer device may determine whether to adjust the video frame or adjust the audio frame. If the video frame change amplitude between the first content progress and the third content progress is less than the amplitude threshold, an information change of an image information type is relatively small within this time period. Therefore, operation S513 may be performed, i.e., the first video frame is subjected to information synchronization adjustment to obtain a video frame configured for simulating the information corresponding to the image information type of the video content at the third content progress. If the video frame change amplitude reaches the amplitude threshold, the image information changes greatly, and distortion occurs when the video frame is adjusted. Therefore, the terminal device may perform operation S514, i.e., adjust the first audio frame.

S512: The terminal device determines whether a progress difference between the second content progress and the third content progress is greater than a third difference threshold.

When determining whether to adjust the first audio frame, the computer device may determine whether there is a relatively large time difference between the second content progress and the third content progress. If the time difference is greater than the third difference threshold, the time difference is relatively large, and the adjustments such as compression and slow playing of the audio information easily causes distortion of the audio information, and therefore, operation S513 may be selected to be performed. If the time difference is not greater than the third difference threshold, a distortion probability of adjusting the audio information is relatively low, and operation S514 may be selected to be performed.

S513: The terminal device performs information synchronization adjustment on the first video frame.

The mode of performing synchronization adjustment on the video frame is mentioned in the foregoing content, and is not described here again.

S514: The terminal device performs information synchronization adjustment on the first audio frame.

The mode of performing synchronization adjustment on the audio frame is mentioned in the foregoing content, and is not described here again.

S515: The terminal device plays the first video frame and the first audio frame after the information synchronization adjustment at the target playing moment.

The content progress difference between the adjusted first video frame and the adjusted first audio frame is less than the first difference threshold, thereby ensuring the information synchronization of the information played at the target playing moment.

It can be seen from the foregoing content that this application can bring technical effects in the following multiple aspects:

According to a first aspect, in this application, the information synchronization adjustment may be performed on the key content having a relatively large impact on the information synchronization of the content browsing experience, and the intensity of the information synchronization adjustment is reduced for the content having a relatively small impact, thereby reducing an information adjustment amount to reduce an information loss amount and an information deformation amount caused by the information synchronization adjustment, improving the fidelity and integrity of the played content, and also improving the information processing efficiency.

According to a second aspect, in this application, the key content can be identified from a plurality of dimensions, thereby improving the identification precision of the target content progress, and improving the information processing accuracy.

According to a third aspect, in this application, during information processing, a type of information to be processed can be selected in a targeted mode, thereby avoiding the reduction of accuracy of the played information caused by information processing, and further ensuring the content browsing experience.

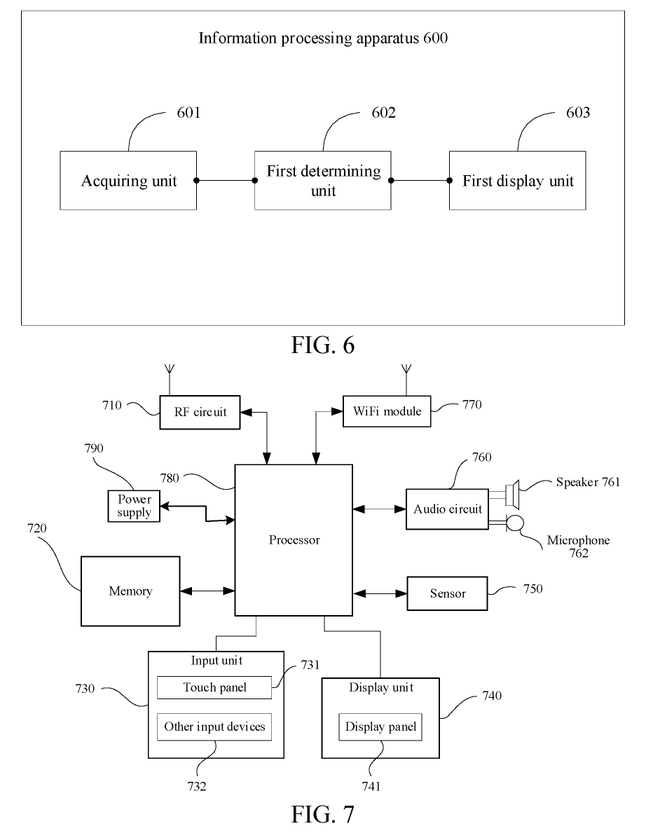

Based on the information processing method according to the foregoing embodiment, this application further provides an information processing apparatus. Referring to FIG. 6, FIG. 6 is a structural block diagram of an information processing apparatus according to an embodiment of this application. An apparatus 600 includes an acquiring unit 601, a first determining unit 602, and a first playing unit 603:

the acquiring unit 601 being configured to acquire first information to be played and second information to be played which are configured to be played at a target playing moment, the first information to be played being information corresponding to a first information type of a target content at a first content progress, the second information to be played being information corresponding to a second information type of the target content at a second content progress, and the first information type and the second information type being different information types;

the first determining unit 602 being configured to determine first information corresponding to the first information type according to the first information to be played, and determine second information corresponding to the second information type according to the second information to be played based on that a target content progress exists in the first content progress and the second content progress and a progress difference between the first content progress and the second content progress is greater than a first difference threshold, information respectively corresponding to the first information type and the second information type both changing when the target content is at the target content progress, and an information change in the first information type being a reason of an information change in the second information type; and

the first playing unit 603 being configured to play the first information and the second information at the target playing moment, a difference between content progresses respectively corresponding to the first information and the second information in the target content being not greater than the first difference threshold.

In a possible implementation, the apparatus further includes a second determining unit and a second playing unit:

the second determining unit being configured to determine third information corresponding to the first information type according to the first information to be played, and determine fourth information corresponding to the second information type according to the second information to be played based on that a target content progress does not exist in the first content progress and the second content progress and a progress difference between the first content progress and the second content progress is greater than a second difference threshold, the second difference threshold being greater than the first difference threshold; and

the second playing unit being configured to play the third information and the fourth information at the target playing moment, a difference between content progresses respectively corresponding to the third information and the fourth information in the target content being not greater than the second difference threshold.

In a possible implementation, the apparatus further includes a third playing unit:

the third playing unit being configured to play the first information to be played and the second information to be played at the target playing moment based on that a progress difference between the first content progress and the second content progress is not greater than the first difference threshold; or

play the first information to be played and the second information to be played at the target playing moment based on that a progress difference between the first content progress and the second content progress is not greater than the second difference threshold and a target content progress does not exist in the first content progress and the second content progress.

In a possible implementation, the first determining unit 602 is specifically configured to:

determine the first information to be played as first information corresponding to the first information type, and determine second information corresponding to the second information type according to the second information to be played, the second information being configured for simulating the information corresponding to the second information type of the target content at a third content progress, and a progress difference between the third content progress and the first content progress being not greater than the first difference threshold.

In a possible implementation, a third content progress is located between the first content progress and the second content progress.

In a possible implementation, the second information type is an audio information type, and the first determining unit 602 is specifically configured to:

determine the first information to be played as first information corresponding to the first information type based on that a progress difference between the second content progress and the first content progress is less than a third difference threshold, and determine second information corresponding to the second information type according to the second information to be played.

In a possible implementation, the second information type is an image information type, and the first determining unit 602 is specifically configured to:

determine the first information to be played as first information corresponding to the first information type based on that the target content is between the second content progress and the third content progress and an information change amplitude of information corresponding to the image information type is less than an amplitude threshold, and determine second information corresponding to the second information type according to the second information to be played.

In a possible implementation, the first information is configured for simulating the information corresponding to the first information type of the target content at a fourth content progress, the second information is configured for simulating the information corresponding to the second information type of the target content at a fifth content progress, and the fourth content progress and the fifth content progress are located between the first content progress and the second content progress.

In a possible implementation, the target content progress is determined by a progress determining process, the progress determining process including:

acquiring first information to be analyzed and second information to be analyzed, respectively corresponding to the first information type, of the target content at a sixth content progress and a seventh content progress, a progress difference between the seventh content progress and the sixth content progress being less than a fourth difference threshold; and

determining the sixth content progress as the target content progress based on that a difference between the first information to be analyzed and the second information to be analyzed is greater than a first information difference threshold.

In a possible implementation, the first information type is an audio information type, the first information difference threshold includes a first energy threshold, the first information to be analyzed is first audio information, the second information to be analyzed is second audio information, and the determining the sixth content progress as the target content progress based on that a difference between the first information to be analyzed and the second information to be analyzed is greater than a first information difference threshold includes:

determining the sixth content progress as the target content progress based on that information energy of the first audio information exceeding the second audio information reaches the first energy threshold.

In a possible implementation, the sixth content progress is after the seventh content progress, the first information difference threshold further includes a second energy threshold, and the progress determining process further includes:

determining the sixth content progress as the target content progress based on that the information energy of the first audio information exceeding the second audio information reaches the second energy threshold, the first audio information includes human voice information, and the second audio information does not include human voice information, the second energy threshold being less than the first energy threshold.

In a possible implementation, the sixth content progress is after the seventh content progress, the first information difference threshold further includes a second energy threshold, and the progress determining process further includes:

determining the sixth content progress as the target content progress based on that the information energy of the first audio information lower than the second audio information reaches the second energy threshold, the second audio information includes human voice information, and the first audio information does not include human voice information, the second energy threshold being less than the first energy threshold.

In a possible implementation, the first information type is an image information type, the first information difference threshold includes an image information difference threshold, the first information to be analyzed is first image information, the second information to be analyzed is second image information, and the determining the sixth content progress as the target content progress based on that a difference between the first information to be analyzed and the second information to be analyzed is greater than a first information difference threshold includes:

determining the sixth content progress as the target content progress based on that a difference between the first image information and the second image information reaches the image information difference threshold.

In a possible implementation, the progress determining process further includes:

acquiring third information to be analyzed and fourth information to be analyzed, respectively corresponding to the second information type, of the target content at the sixth content progress and the seventh content progress; and

the determining the sixth content progress as the target content progress based on that a difference between the first information to be analyzed and the second information to be analyzed is greater than a first information difference threshold includes:

determining the sixth content progress as the target content progress based on that a difference between the first information to be analyzed and the second information to be analyzed is greater than a first information difference threshold, and a difference between the third information to be analyzed and the fourth information to be analyzed is greater than a second information difference threshold.

In a possible implementation, the target content progress is determined by a progress determining process, the progress determining process including:

acquiring information to be analyzed, corresponding to a target information type, of the target content at an eighth content progress, the target information type being the first information type or the second information type; and

determining the eighth content progress as the target content progress based on that the information to be analyzed includes content identification information corresponding to the target information type, the content identification information being information corresponding to the target information type of a target sub-content, the target sub-content being a content causing an information change in the first information type and the second information type, and an information change in the first information type being a reason of an information change in the second information type.

In a possible implementation, the progress determining process further includes:

adding a target identifier to the first information to be analyzed and third information to be analyzed based on determining the sixth content progress as the target content progress, the third information to be analyzed being information corresponding to the second information type of the target content at the sixth content progress; and

the first determining unit 602 is specifically configured to:

determine first information corresponding to the first information type according to the first information to be played, and determine second information corresponding to the second information type according to the second information to be played based on that information including the target identifier exists in the first information to be played and the second information to be played and a progress difference between the first content progress and the second content progress is greater than a first difference threshold.

In a possible implementation, the method is applied to a first device on an information playing side, and the progress determining process is performed by a second device on an information transmitting side, the second device being configured to transmit information respectively corresponding to the first information type and the second information type of the target content to the first device.

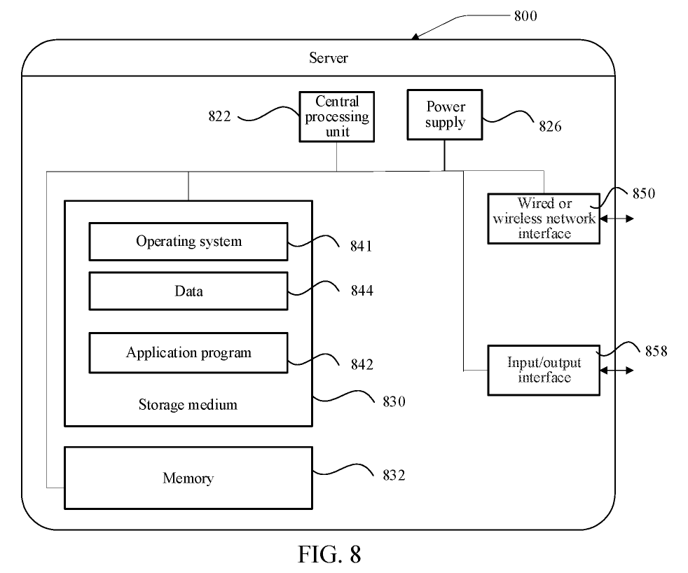

An embodiment of this application further provides a computer device. Referring to FIG. 7, the computer device may be a terminal device. An example in which the terminal device is a mobile phone is taken.

FIG. 7 is a block diagram of a structure of a part of a mobile phone related to a terminal device according to an embodiment of this application. Referring to FIG. 7, the mobile phone includes: a radio frequency (RF) circuit 710, a memory 720, an input unit 730, a display unit 740, a sensor 750, an audio circuit 760, a wireless fidelity (Wi-Fi) module 770, a processor 780, and a power supply 790. Those skilled in the art may understand that the structure of the mobile phone shown in FIG. 7 does not constitute a limitation to the mobile phone, and the mobile phone may include more or fewer components than those shown in the figure, or some components may be combined, or a different component deployment may be used.

The following specifically introduces the components of the mobile phone with reference to FIG. 7.

The RF circuit 710 may be configured to receive and transmit signals during an information receiving and transmitting process or a call process. Specifically, the RF circuit receives downlink information from a base station, then delivers the downlink information to the processor 780 for processing, and transmits designed uplink data to the base station.

The memory 720 may be configured to store a software program and a module. The processor 780 runs the software program and the module stored in the memory 720, to implement various functional applications and data processing of the mobile phone.

The input unit 730 may be configured to receive inputted digit or character information, and generate a key signal input related to user settings and function control of the mobile phone. Specifically, the input unit 730 may include a touch panel 731 and other input devices 732.

The display unit 740 may be configured to display information inputted by the user or information provided for the user, and various menus of the mobile phone. The display unit 740 may include a display panel 741.

The mobile phone may further include at least one sensor 750 such as an optical sensor and a motion sensor.

The audio circuit 760, a speaker 761, and a microphone 762 may provide audio interfaces between the user and the mobile phone. The audio circuit 760 may convert the received audio data into an electric signal and transmit the electric signal to the speaker 761, and the electric signal is converted by the speaker 761 into a sound signal to be outputted. In another aspect, the microphone 762 converts the collected sound signal into an electric signal. The audio circuit 760 receives the electric signal, converts the electric signal into audio data, and outputs the audio data to the processor 780 for processing to transmit the processed audio data to another mobile phone through the RF circuit 710; or outputs the audio data to the memory 720 for further processing.

The processor 780 is a control center of the mobile phone, and is connected to various parts of the entire mobile phone by using various interfaces and lines. By running or executing the software program and/or the module stored in the memory 720, and invoking the data stored in the memory 720, the processor executes various functions of the mobile phone and performs data processing, thereby monitoring the entire mobile phone. In some embodiments, the processor 780 may include one or more processing units. Preferably, the processor 780 may integrate an application processor and a modem processor, where the application processor mainly handles an operating system, a user interface, application programs, etc., and the modem processor mainly handles wireless communication. The foregoing modem processor may alternatively not be integrated into the processor 780.

The mobile phone further includes a power supply 790 (such as a battery) for supplying power to the various components.

Although not shown in the figure, the mobile phone may further include a camera and a Bluetooth module, which are not described in detail here.

In this embodiment, the processor 780 included in the terminal device further has the following functions of:

acquiring first information to be played and second information to be played which are configured to be played at a target playing moment, the first information to be played being information corresponding to a first information type of a target content at a first content progress, the second information to be played being information corresponding to a second information type of the target content at a second content progress, and the first information type and the second information type being different information types;

determining first information corresponding to the first information type according to the first information to be played, and determining second information corresponding to the second information type according to the second information to be played based on that a target content progress exists in the first content progress and the second content progress and a progress difference between the first content progress and the second content progress is greater than a first difference threshold, information respectively corresponding to the first information type and the second information type both changing when the target content is at the target content progress, and an information change in the first information type being a reason of an information change in the second information type; and

playing the first information and the second information at the target playing moment, a difference between content progresses respectively corresponding to the first information and the second information in the target content being not greater than the first difference threshold.

An embodiment of this application further provides a server. Referring to FIG. 8, FIG. 8 is a structural diagram of a server 800 according to an embodiment of this application. The server 800 greatly differs due to different configurations or performance, and may include one or more central processing units (CPUs) 822 (for example, one or more processors), a memory 832, and one or more storage media 830 (for example, one or more mass storage devices) for storing an application program 842 or data 844. The memory 832 and the storage medium 830 may be transient or persistent storages. A program stored in the storage medium 830 may include one or more modules (not shown), and each module may include a series of instruction operations on the server. Further, the central processing unit 822 may be configured to communicate with the storage medium 830, and execute, on the server 800, the series of instruction operations in the storage medium 830.

The server 800 may further include one or more power supplies 826, one or more wired or wireless network interfaces 850, one or more input/output interfaces 858, and/or one or more operating systems 841, such as Windows Server^{TM}, Mac OS X^{TM}, Unix^{TM}, Linux^{TM}, and FreeBSD^{TM}.

The operations performed by the server in the foregoing embodiment may be based on the structure of the server shown in FIG. 8.

An embodiment of this application further provides a computer-readable storage medium, configured to store a computer program, the computer program being configured to perform any implementation of the information processing method described in the foregoing embodiments.

An embodiment of this application further provides a computer program product including a computer program. When the computer program product is run on a computer device, the computer device is enabled to perform the information processing method according to any one of the foregoing embodiments.

In the specific implementation of this application, related data such as user information (e.g., human voice information and person images) is involved. When the foregoing embodiments of this application are applied to a specific product or technology, a permission or consent of a user is required, and collection, use, and processing of the related data need to comply with relevant laws, regulations, and standards of relevant countries and regions.

Those of ordinary skill in the art may understand that all or some of the operations of the foregoing method embodiments may be implemented by a program instructing relevant hardware. The foregoing program may be stored in a computer-readable storage medium. When the program runs, the operations of the foregoing method embodiments are performed. The foregoing storage medium may be at least one of the following media: any medium that can store program code, such as a read-only memory (ROM), a RAM, a magnetic disk, or an optical disc.

The embodiments in this specification are all described in a progressive mode. For same or similar parts in the embodiments, reference may be made to these embodiments, and each embodiment focuses on a difference from other embodiments. Especially, device and system embodiments are basically similar to the method embodiments, and therefore are described briefly. For related parts, reference may be made to partial descriptions in the method embodiments. The described device and system embodiments are merely exemplary. The units described as separate parts may or may not be physically separated, and parts displayed as units may or may not be physical units, may be located in one position, or may be distributed on a plurality of network units. Some or all of the modules may be selected according to actual needs to achieve the objectives of the solutions of the embodiments. Those of ordinary skill in the art may understand and implement the embodiments without creative efforts.

The foregoing descriptions are merely a specific implementation of this application, but are not intended to limit the protection scope of this application. Any variation or replacement readily figured out by those skilled in the art within the technical scope disclosed in this application shall fall within the protection scope of this application. Therefore, the protection scope of this application shall be subject to the protection scope of the claims.

What is claimed is:

1. An information processing method performed by a computer device, the method comprising:
acquiring first information to be played and second information to be played which are configured to be played at a target playing moment, the first information to be played corresponding to a first information type of a target content at a first content progress, the second information to be played corresponding to a second information type of the target content at a second content progress;
determining first information corresponding to the first information type according to the first information to be played, and second information corresponding to the second information type according to the second information to be played when the second content progress and a progress difference between the first content progress and the second content progress is greater than a first difference threshold; and
playing the first information and the second information at the target playing moment, a difference between content progresses respectively corresponding to the first information and the second information in the target content being not greater than the first difference threshold.

2. The method according to claim 1, further comprising:
determining third information corresponding to the first information type according to the first information to be played, and determining fourth information corresponding to the second information type according to the second information to be played based on that a target content progress does not exist in the first content progress and the second content progress and a progress difference between the first content progress and the second content progress is greater than a second difference threshold, the second difference threshold being greater than the first difference threshold; and
playing the third information and the fourth information at the target playing moment, a difference between content progresses respectively corresponding to the third information and the fourth information in the target content being not greater than the second difference threshold.

3. The method according to claim 2, further comprising:
playing the first information to be played and the second information to be played at the target playing moment based on that a progress difference between the first content progress and the second content progress is not greater than the first difference threshold; or
playing the first information to be played and the second information to be played at the target playing moment based on that a progress difference between the first content progress and the second content progress is not greater than the second difference threshold and the target content progress does not exist in the first content progress and the second content progress.

4. The method according to claim 1, wherein the determining first information corresponding to the first information type according to the first information to be played, and second information corresponding to the second information type according to the second information to be played comprises:
determining the first information to be played as first information corresponding to the first information type, and determining second information corresponding to the second information type according to the second information to be played, the second information being configured for simulating the information corresponding to the second information type of the target content at a third content progress, and a progress difference between the third content progress and the first content progress being not greater than the first difference threshold.

5. The method according to claim 4, wherein the second information type is an audio information type, and the determining the first information to be played as first information corresponding to the first information type, and determining second information corresponding to the second information type according to the second information to be played comprises:
determining the first information to be played as first information corresponding to the first information type based on that a progress difference between the second content progress and the first content progress is less than a third difference threshold, and determining second information corresponding to the second information type according to the second information to be played.

6. The method according to claim 4, wherein the second information type is an image information type, and the determining the first information to be played as first information corresponding to the first information type, and determining second information corresponding to the second information type according to the second information to be played comprises:
determining the first information to be played as first information corresponding to the first information type based on that the target content is between the second content progress and the third content progress and an information change amplitude of information corresponding to the image information type is less than an amplitude threshold, and determining second information corresponding to the second information type according to the second information to be played.

7. The method according to claim 1, wherein the first information is configured for simulating the information corresponding to the first information type of the target content at a fourth content progress, the second information is configured for simulating the information corresponding to the second information type of the target content at a fifth content progress, and the fourth content progress and the fifth content progress are located between the first content progress and the second content progress.

8. The method according to claim 1, wherein the target content progress is determined by a progress determining process, the progress determining process comprising:
acquiring first information to be analyzed and second information to be analyzed, respectively corresponding to the first information type, of the target content at a sixth content progress and a seventh content progress, a progress difference between the seventh content progress and the sixth content progress being less than a fourth difference threshold; and
determining the sixth content progress as the target content progress based on that a difference between the first information to be analyzed and the second information to be analyzed is greater than a first information difference threshold.

9. The method according to claim 8, wherein the first information type is an audio information type, the first information difference threshold comprises a first energy threshold, the first information to be analyzed is first audio information, the second information to be analyzed is second audio information, and the determining the sixth content progress as the target content progress based on that a difference between the first information to be analyzed and the second information to be analyzed is greater than a first information difference threshold comprises:
determining the sixth content progress as the target content progress based on that information energy of the first audio information exceeding the second audio information reaches the first energy threshold.

10. The method according to claim 9, wherein the sixth content progress is after the seventh content progress, the first information difference threshold further comprises a second energy threshold, and the progress determining process further comprises:
determining the sixth content progress as the target content progress based on that the information energy of the first audio information exceeding the second audio information reaches the second energy threshold, the first audio information comprises human voice information, and the second audio information does not comprise human voice information, the second energy threshold being less than the first energy threshold.

11. The method according to claim 9, wherein the sixth content progress is after the seventh content progress, the first information difference threshold further comprises a second energy threshold, and the progress determining process further comprises:
determining the sixth content progress as the target content progress based on that the information energy of the first audio information lower than the second audio information reaches the second energy threshold, the second audio information comprises human voice information, and the first audio information does not comprise human voice information, the second energy threshold being less than the first energy threshold.

12. The method according to claim 8, wherein the first information type is an image information type, the first information difference threshold comprises an image information difference threshold, the first information to be analyzed is first image information, the second information to be analyzed is second image information, and the determining the sixth content progress as the target content progress based on that a difference between the first information to be analyzed and the second information to be analyzed is greater than a first information difference threshold comprises:
determining the sixth content progress as the target content progress based on that a difference between the first image information and the second image information reaches the image information difference threshold.

13. The method according to claim 8, wherein the progress determining process further comprises:
acquiring third information to be analyzed and fourth information to be analyzed, respectively corresponding to the second information type, of the target content at the sixth content progress and the seventh content progress; and
the determining the sixth content progress as the target content progress based on that a difference between the first information to be analyzed and the second information to be analyzed is greater than a first information difference threshold comprises:
determining the sixth content progress as the target content progress based on that a difference between the first information to be analyzed and the second information to be analyzed is greater than a first information difference threshold, and a difference between the third information to be analyzed and the fourth information to be analyzed is greater than a second information difference threshold.

14. The method according to claim 1, wherein the target content progress is determined by a progress determining process, the progress determining process comprising:
acquiring information to be analyzed, corresponding to a target information type, of the target content at an eighth content progress, the target information type being the first information type or the second information type; and
determining the eighth content progress as the target content progress based on that the information to be analyzed comprises content identification information corresponding to the target information type, the content identification information being information corresponding to the target information type of a target sub-content, the target sub-content being a content causing an information change in the first information type and the second information type, and an information change in the first information type being a reason of an information change in the second information type.

15. The method according to claim 8, wherein the progress determining process further comprises:
adding a target identifier to the first information to be analyzed and third information to be analyzed based on determining the sixth content progress as the target content progress, the third information to be analyzed being information corresponding to the second information type of the target content at the sixth content progress; and
the determining first information corresponding to the first information type according to the first information to be played, and determining second information corresponding to the second information type according to the second information to be played based on that a target content progress exists in the first content progress and the second content progress and a progress difference between the first content progress and the second content progress is greater than a first difference threshold comprises:
determining first information corresponding to the first information type according to the first information to be played, and determining second information corresponding to the second information type according to the second information to be played based on that information comprising the target identifier exists in the first information to be played and the second information to be played and a progress difference between the first content progress and the second content progress is greater than a first difference threshold.

16. The method according to claim 8, wherein the method is applied to a first device on an information playing side, and the progress determining process is performed by a second device on an information transmitting side, the second device being configured to transmit information respectively corresponding to the first information type and the second information type of the target content to the first device.

17. The method according to claim 1, wherein information respectively corresponding to the first information type and the second information type both changes when the target content is at the target content progress.

18. The method according to claim 2, wherein an information change in the first information type causes an information change in the second information type.

19. A computer device, comprising a processor and a memory:
the memory being configured to store a computer program and transmit the computer program to the processor; and
the processor being configured to perform an information processing method including:
acquiring first information to be played and second information to be played which are configured to be played at a target playing moment, the first information to be played corresponding to a first information type of a target content at a first content progress, the second information to be played corresponding to a second information type of the target content at a second content progress;
determining first information corresponding to the first information type according to the first information to be played, and second information corresponding to the second information type according to the second information to be played when the second content progress and a progress difference between the first content progress and the second content progress is greater than a first difference threshold; and
playing the first information and the second information at the target playing moment, a difference between content progresses respectively corresponding to the first information and the second information in the target content being not greater than the first difference threshold.

20. A non-transitory computer-readable storage medium, configured to store a computer program, the computer program, when executed by a processor of a computer device being configured for performing an information processing method including:
acquiring first information to be played and second information to be played which are configured to be played at a target playing moment, the first information to be played corresponding to a first information type of a target content at a first content progress, the second information to be played corresponding to a second information type of the target content at a second content progress;
determining first information corresponding to the first information type according to the first information to be played, and second information corresponding to the second information type according to the second information to be played when the second content progress and a progress difference between the first content progress and the second content progress is greater than a first difference threshold; and
playing the first information and the second information at the target playing moment, a difference between content progresses respectively corresponding to the first information and the second information in the target content being not greater than the first difference threshold.
